(19) United States
(12) Patent Application Publication
(10) Pub. No.: US 2014/0114503 A1
(43) Pub. Date: Apr. 24, 2014

(54) Remote Function Fob for a Vehicle Passive Entry Passive Start System and Method for Operating Same

(71) Applicant: Lear Corporation, Southfield, MI (US)

(72) Inventors: Riad Ghabra, Northville, MI (US); Jason Summerford, Novi, MI (US)

(73) Assignee: Lear Corporation, Southfield, MI (US)

(21) Appl. No.: 14/041,165

(22) Filed: Sep. 30, 2013

Related U.S. Application Data
(60) Provisional application No. 61/717,786, filed on Oct. 24, 2012.

(51) Int. Cl. G06F 7/00

(52) U.S. Cl. CPC G06F 7/00
USPC 701/2

(57) ABSTRACT

A remote function fob is disclosed for a passive entry-passive start (PEPS) system for a vehicle. The fob may include a battery, a low frequency (LF) receiver, and a controller. The controller may be configured to enable a low current consumption mode wherein the LF receiver is disabled such that the fob is unable to respond to a PEPS request signal transmitted from a vehicle control module. A method is also disclosed which may include enabling a low current consumption mode wherein a fob receiver is disabled such that the fob is unable to respond to a PEPS request signal transmitted from a vehicle control module. In such a fashion, a shelf-life of the fob battery may be extended.

### CROSS-REFERENCE TO RELATED APPLICATIONS

The present application claims the benefit of U.S. Provisional Patent Application No. 61/717,786 filed on Oct. 24, 2012, the disclosure of which is incorporated in its entirety by reference herein.

### TECHNICAL FIELD

The following relates to a remote function fob for a passive entry-passive start (PEPS) system for a vehicle, and a method for operating such a fob.

### BACKGROUND

Passive entry and passive start systems for vehicles and the operation of those systems are well known in the automotive field. Such systems typically include a portable remote control device, which may be referred to as a fob, and a controller or control module mounted in the vehicle.

Such a fob is usually a battery powered, hand-held device and may include a radio frequency (RF) transmitter and a low frequency (LF) receiver for wirelessly transmitting RF signals and receiving LF signals. Such signals are transmitted to and received from corresponding transmitters and receivers associated with the vehicle-mounted control module, and are provided for use in automatically performing certain vehicle functions, and may include commands for use in door lock/unlock, engine start, and other vehicle functions.

Examples of known remote keyless entry (RKE) and passive entry systems include U.S. Pat. No. 5,515,036 entitled “Passive Keyless Entry System,” U.S. Pat. No. 6,617,975 entitled “Keyless Entry System For Vehicles In Particular,” and U.S. Pat. No. 7,106,171 entitled “Keyless Command System For Vehicles And Other Applications.”

A Battery powered PEPS fob typically has a significant Q-current that can significantly shorten the battery life of the fob to 2-3 years. If the fob sits in storage for 1-2 years, the remaining battery life for operational use of the fob may be very short. Such a shortened fob battery life may not meet customer requirements for operational battery life.

Thus, there exists a need for a PEPS fob and a method for operating such a fob that would enable managing the Q-current of the fob while in storage so as to minimize battery life loss. Such a PEPS fob and method for operating the fob would thereby be capable of meeting customer operational battery life requirements.

### SUMMARY

According to one of the embodiments described herein, a remote function fob is provided for a passive entry-passive start (PEPS) system for a vehicle. The fob may comprise a battery, a low frequency (LF) receiver, and a controller. The controller may be configured to enable a low current consumption mode wherein the LF receiver is disabled such that the fob is unable to respond to a PEPS request signal transmitted from a vehicle control module.

According to another embodiment described herein, a remote function fob is provided for a passive entry-passive start (PEPS) system for a vehicle. The fob may comprise a battery, a radio frequency (RF) transceiver, and a controller. The controller may be configured to enable a low current consumption mode wherein the RF transceiver is disabled such that the fob is unable to respond to a PEPS request signal transmitted from a vehicle control module.

According to another embodiment described herein, a method is provided for operating a remote function fob for a passive entry-passive start (PEPS) system for a vehicle. The fob may comprise a battery, a receiver, and a controller for controlling operation of the fob. The method may comprise enabling a low current consumption mode wherein the receiver is disabled such that the fob is unable to respond to a PEPS request signal transmitted from a vehicle control module.

A detailed description of these and other embodiments of a fob and method for operating a fob for a passive entry-passive start (PEPS) system for a vehicle is set forth below together with the accompanying drawings.

### BRIEF DESCRIPTION OF THE DRAWINGS

FIG. 1 is a simplified block diagram of an embodiment of a remote function fob for a passive entry-passive start (PEPS) system for a vehicle, as described herein;

FIG. 2 is a simplified block diagram of another embodiment of a remote function fob for a PEPS system for a vehicle, as described herein; and

FIG. 3 is a simplified block diagram of another embodiment of a remote function fob for a PEPS system for a vehicle and an embodiment of a method for operating such a fob, as described herein.

### DETAILED DESCRIPTION

As required, detailed embodiments are disclosed herein. However, it is to be understood that the disclosed embodiments are merely exemplary and may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

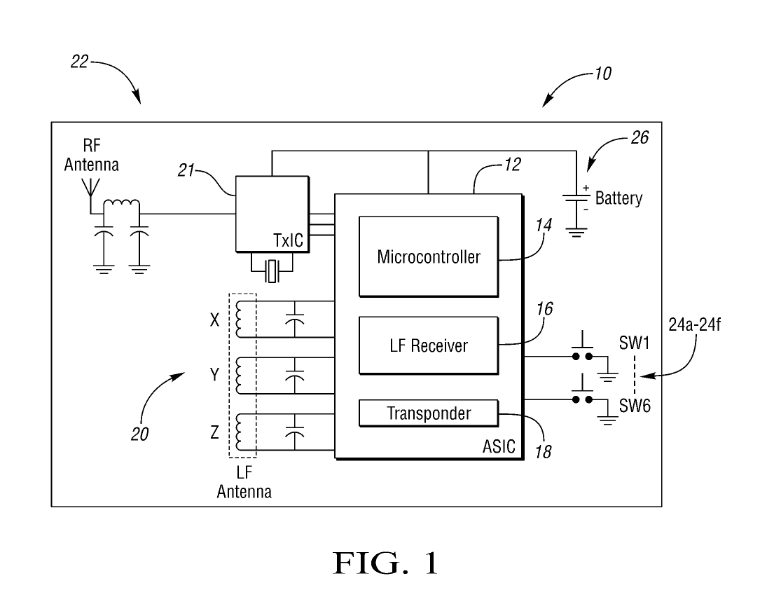

With reference to FIGS. 1-3, a more detailed description of embodiments of a fob and a method for operating a fob for a passive entry-passive start (PEPS) system for a vehicle will be described. For ease of illustration and to facilitate understanding, like reference numerals have been used herein for like components and features throughout the drawings.

As previously described, passive entry and passive start systems for vehicles and the operation of those systems are well known in the automotive field. Such systems typically include a portable remote control device, which may be referred to as a fob, and a controller or control module mounted in the vehicle.

Such a fob is usually a battery powered, hand-held device and may include a radio frequency (RF) transmitter and a low frequency (LF) receiver for wirelessly transmitting RF signals and receiving LF signals. Such signals are transmitted to and received from corresponding transmitters and receivers associated with the vehicle-mounted control module, and are provided for use in automatically performing certain vehicle functions, and may include commands for use in door lock/unlock, engine start, and other vehicle functions.

Examples of known remote keyless entry (RKE) and passive entry systems include U.S. Pat. No. 5,515,036 entitled “Passive Keyless Entry System,” U.S. Pat. No. 6,617,975 entitled “Keyless Entry System For Vehicles In Particular,” and U.S. Pat. No. 7,106,171 entitled “Keyless Command System For Vehicles And Other Applications.”

A Battery powered PEPS fob typically has a significant Q-current that can significantly shorten the battery life of the fob to 2-3 years. If the fob sits in storage for 1-2 years, the remaining battery life for operational use of the fob may be very short. Such a shortened fob battery life may not meet customer requirements for operational battery life.

Thus, there exists a need for a PEPS fob and a method for operating such a fob that would enable managing the Q-current of the fob while in storage so as to minimize battery life loss. Such a fob and method for operating the fob would thereby be capable of meeting customer operational battery life requirements.

As seen in FIG. 1, one embodiment of a portable, remote control device, such as a fob 10 for use in a passive entry-passive start (PEPS) system for a vehicle is shown. The fob 10 may comprise an Application Specific Integrated Circuit (ASIC) 12 that may comprise a microcontroller 14, a low frequency (LF) receiver 16, and a transponder 18. The microcontroller 14, which may also be referred to as a control unit, electronic control unit (ECU), or controller, may comprise a microprocessor, programmable digital signal processor (DSP) or other programmable device. The microcontroller 14 may alternatively include an ASIC, a programmable gate array or programmable array logic, or a programmable logic device. Where microcontroller 14 includes a programmable device such as a microprocessor or programmable DSP, the microcontroller 14 may further include computer executable code that controls operation of the device.

The LF receiver 16 and transponder 18 may operate in conjunction with an LF antenna 20, which is provided in communication with the ASIC 12 and may comprise a plurality of antennas having different orientations (X, Y, Z) to improve signal transmission and/or reception. The LF antenna 20 and receiver 16 are configured or adapted, in an active or battery-powered operating mode, to receive a PEPS request LF signal or other PEPS related LF signals. The LF antenna 20 and transponder 18 are also configured or adapted, in a battery-less operating mode, to send and receive non-PEPS related LF signals.

The fob 10 may further comprise a radio frequency (RF) transmitter or transceiver provided in communication with the ASIC 12. The RF transmitter may comprise a transmitter integrated circuit (Tx IC) 21 configured or adapted for cooperation with an RF antenna 22. The RF antenna 22 and transmitter or transceiver are configured to transmit or transmit and receive PEPS related RF signals, which may be ultra-high frequency (UHF) signals, such as in the 300-500 MHz range. The fob 10 may also comprise one or more user operable switches 24a-24f, which may take the form of buttons or any other form well known in the art. The fob 10 still further comprises a battery 26 for powering the various fob components described herein.

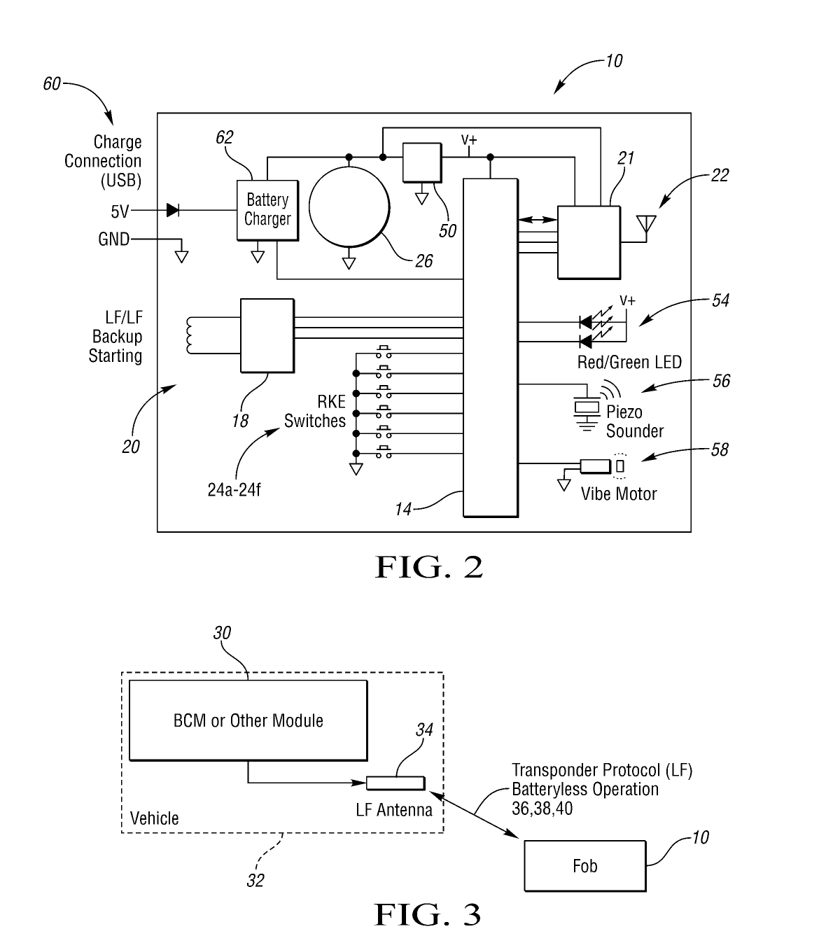

FIG. 2 illustrates another embodiment of a portable, remote control device, such as a fob 10 for use in a passive entry-passive start (PEPS) system for a vehicle. The fob 10 may comprise a microcontroller 14 and a low frequency transponder 18. The transponder 18 may operate in conjunction with an LF antenna 20. Although only a single LF antenna 20 is shown, a plurality of antennas may be employed having different orientations (X, Y, Z) to improve signal transmission and/or reception. The LF antenna 20 and transponder 18 are configured or adapted for operation, in a battery-less operating mode, to send and receive non-PEPS related LF signals. The LF antenna 20 and transponder 18 may also be provided for use with a vehicle mounted immobilizer reader or immobilizer base station (not shown) having a corresponding LF antenna (not shown) to enable a vehicle immobilization function and/or for LF/LF backup vehicle starting.

The fob 10 may further comprise a radio frequency (RF) transmitter or transceiver, which may include a transceiver integrated circuit 21 and RF antenna 22. The RF antenna 22 and transceiver 21 may be configured to transmit and receive PEPS related RF signals, which may be ultra-high frequency (UHF) signals. The fob 10 may also comprise one or more user operable switches 24a-24f, which may take the form of buttons or any other form well known in the art. The fob 10 still further comprises a battery 26 for powering the various fob components described herein.

Still referring to FIG. 2, the fob 10 may also comprise a voltage regulator 50. The fob 10 may further comprise various additional electrical or electronic components acting as output devices, such as light-emitting diodes 54, a piezoelectric sound generator 56, and a motor 58 for generating vibrations.

Referring now to FIGS. 1 and 2, according to the embodiments described herein, extending the shelf-life of the fob battery 26 may be accomplished in various ways. In that regard, where the fob 10 includes switches 24a-24f, according to one embodiment, as much circuitry in the fob 10 is turned off as possible while still maintaining a minimum operation so as to be able to wake up the fob via actuation of one or more switches 24a-24f, such as by pressing one or more buttons, which may include a sequence of switch actuations or button presses. This may include disabling or shedding any other electrical load or components such as the LEDs 54, piezoelectric sound generator 56, and motor 58. This is done to reduce standby current consumption. In this low current consumption or storage mode, the fob 10 is not fully operational especially for PEPS functions. That is, the LF receiver 16 (FIG. 1) or the RF transceiver 21 (FIG. 2) is disabled such that the fob is unable to respond to a PEPS request LF or RF signal transmitted from a vehicle mounted control module.

In another embodiment, once again as much circuitry in the fob 10 is turned off as possible while still maintaining a minimum operation so as to be able to wake up the fob when the fob is mated to a vehicle. This may again include disabling or shedding any other electrical load or components, such as the LEDs 54, piezoelectric sound generator 56, and motor 58. Here again, this is done to reduce standby current consumption. In this low current consumption or storage mode, the fob 10 again is not fully operational especially for PEPS functions.

When fob 10 is mated to the vehicle, a wake up command may be communicated to the fob 10 and the fob 10 re-configured so as to turn on all needed circuitry to enable the PEPS function, whereby the LF receiver 16 (FIG. 1) or RF transceiver 21 (FIG. 2) is enabled such that the fob 10 is able to respond to a vehicle controller PEPS request. In one embodiment, as described in further detail below with reference to FIG. 3, the wake up and re-configuration is done using a battery-less transponder mode (which may also be referred to as an immobilizer mode).

Referring again to FIG. 2, the fob 10 may comprise a port 60, which may take the form of a universal serial bus (USB) connection adapted or configured to receive a USB connector to establish a wired connection with an external device (not shown). Such a port 60 and connection may be provided and used for re-charging the battery 26 of the fob 10. To that end, the fob 10 may also comprise a battery charger 62. The port 60 may also be provided for use in communication with the controller 14, which may be configured to receive a wake-up signal via port 60. In this embodiment, the controller 14 is further configured to place the fob 10 in or enable the normal operating mode in response to the wake-up signal, wherein the RF transceiver 21 is enabled such that the fob 10 is able to respond to a vehicle controller PEPS request.

FIG. 3 is a block diagram of another embodiment of a fob and a method for operating a fob for a passive entry-passive start (PEPS) system for a vehicle. As seen therein, and as will be described in further detail below, the fob 10 may wirelessly communicate with a control module 30 mounted in a vehicle 32 via an LF antenna 34 also mounted in the vehicle 32. The control module 30, which may also be referred to as a Body Control Module (BCM), control unit, electronic control unit (ECU), or controller may comprise a microprocessor, microcontroller, programmable digital signal processor (DSP) or other programmable device. The control module 30 may also, or instead, include an application specific integrated circuit (ASIC), a programmable gate array or programmable array logic, or a programmable logic device. Where the control module 30 includes a programmable device such as a microprocessor, microcontroller or programmable DSP, the control module 30 may further include computer executable code that controls operation of the device.

Referring again to FIGS. 1 and 2, the microcontroller 14 of the fob 10 may be appropriately configured to place the fob 10 in very low current consumption mode. This means that the LF receiver 16 or the RF transceiver 21 is entirely disabled and the microcontroller 14 is set to a very low current mode. In that regard, when placed in a typical standby mode known in the art, an LF receiver 16 consumes significant current (e.g., a few micro amps). In such a standby mode, the fob 10 is able to wake upon receipt of valid LF messages and can therefore take part in processing a PEPS request.

According to the embodiments described herein, however, when the fob 10 is placed in the low current consumption or storage mode, the fob 10 is not able to wake up on any PEPS requests. When the fob 10 is manufactured, an end of line (EOL) tester may be used to test the PEPS function (along with all other functions) of the fob 10, and then may send a special command to the microcontroller 14 to set the fob 10 in a very low current mode, including disabling the LF receiver 16 (FIG. 1) or RF transceiver 21 (FIG. 2). After this message is sent, the fob 10 is unable to wake up on any PEPS requests. Therefore, the fob 10 is placed in this storage mode towards the end of the EOL testing process.

As previously described, the fob 10 may be awakened from such a low current consumption mode and returned to a normal operating mode by pressing a button or sequence of buttons 24a-24f, or during the process of mating the fob 10 to a particular vehicle at the time of vehicle production. In such a fashion, the LF receiver 16 (FIG. 1) or the RF transceiver 21 (FIG. 2) is enabled so that the fob 10 responds to PEPS request signals.

Alternatively, referring again to FIG. 3, the fob 10 may be placed in the vicinity of the vehicle-mounted LF antenna 34 that is part of the vehicle PEPS system, thereby placing the fob 10 in the field of such a vehicle LF antenna 34. A command may then be sent to the vehicle control module 30 to start the mating process. The vehicle module 30, which may be a Body Control Module (BCM), may then send a transponder command 36 to the fob 10 for receipt by LF antenna 20 and fob transponder 18 functioning in a battery-less operating mode. Transponder command 36 thereby initiates battery-less LF communication with the fob 10 wherein components of the fob 10 may be powered by that received signal. It should be noted that while the BCM 30 is shown in FIG. 3 as connected to the LF antenna 34, any other alternative architecture or configuration may be employed. For example, the BCM 30 could drive another module (not shown) connected to the LF antenna 34, or the BCM 30 and LF antenna 34 could be provided in communication via a vehicle bus or network (not shown), such as a Controller Area Network (CAN).

Upon receipt by the fob transponder 18 of such a transponder command 36, the fob 10 wakes up and responds 38. The vehicle control module 30 may then send a special LF command 40 within the transponder mode to the fob 10. The microcontroller 14 may be configured or adapted, upon receipt of that special LF command 40, to restore or enable the normal operation mode of the fob 10 wherein the LF receiver 16 (FIG. 1) or the RF transceiver 21 (FIG. 2) of the fob 10 is enabled or turned on, as well as perhaps other components of the fob 10 described herein.

Alternatively, as previously describe in connection with FIG. 2, the fob 10 may be provided with a port, plug, connector or other interface 60 for establishing a wired connection of the microcontroller 14 to an external device (not shown) in order to receive a wake-up message. In that regard, the fob 10 may for example be plugged into a universal serial bus (USB) for receiving a wake-up message via a USB connector and connection. In either event, the mating process, which may comprise writing a secret key and other data may be undertaken, as is well known in the art. As a result of the mating process, the fob 10 is learned by the vehicle 32 and is placed in normal operating mode wherein the LF receiver 16 (FIG. 1) or the RF transceiver 21 (FIG. 2) is enabled so that the fob 10 can process all function requests including PEPS.

Thus, a remote function fob for a passive entry-passive start (PEPS) system for a vehicle may comprise a battery, a low frequency (LF) receiver, and a controller configured to enable a low current consumption mode wherein the LF receiver is disabled such that the fob is unable to respond to a PEPS request signal transmitted from a vehicle control module. The fob may further comprise at least one user operable switch, wherein the controller is further configured to enable a normal operating mode in response to actuation of the at least one switch such that the LF receiver is enabled and the fob is able to respond to a PEPS request signal transmitted from a vehicle control module.

Alternatively, the remote function fob may further comprise a transponder adapted for battery-less operation, wherein the controller is further configured to enable a normal operating mode in response to an LF signal received by the transponder such that the LF receiver is enabled and the fob is able to respond to a PEPS request signal transmitted from a vehicle control module. In one embodiment, the fob may further comprise a radio frequency (RF) transmitter, wherein the RF transmitter is disabled in the low current consumption mode. The low current consumption mode may comprise a storage mode wherein a shelf-life of the battery is extended, and the controller may enable the low current consumption mode in response to receipt of a command signal.

In another embodiment, a remote function fob for a passive entry-passive start (PEPS) system for a vehicle may comprise a battery, a radio frequency (RF) transceiver, and a controller configured to enable a low current consumption mode wherein the RF transceiver is disabled such that the fob is unable to respond to a PEPS request signal transmitted from a vehicle control module. The remote fob may further comprise at least one user operable switch, wherein the controller is further configured to enable a normal operating mode in response to actuation of the at least one switch such that the RF transceiver is enabled and the fob is able to respond to a PEPS request signal transmitted from a vehicle control module.

Alternatively, the remote function fob may comprise a transponder configured for battery-less operation, wherein the controller is further configured to enable a normal operating mode in response to a low frequency signal received by the transponder such that the RF transceiver is enabled and the fob is able to respond to a PEPS request signal transmitted from a vehicle control module. The fob may further comprising a port in communication with the controller and configured to receive a wired connection, wherein the controller is further configured to enable a normal operating mode in response to a wake-up signal received via the wired connection such that the RF transceiver is enabled and the fob is able to respond to a PEPS request signal transmitted from a vehicle control module.

The low current consumption mode may comprise a storage mode wherein a shelf-life of the battery is extended, and the controller may enable the low current consumption mode in response to receipt of a command signal. The fob may further comprise at least one component selected from the group comprising a light emitting diode, a piezoelectric sound generator, and a vibration generating motor, wherein the low current consumption mode includes disabling the at least one component.

A method for operating a remote function fob for a passive entry-passive start (PEPS) system for a vehicle, the fob comprising a battery, a receiver, and a controller for controlling operation of the fob, may comprise enabling a low current consumption mode wherein the receiver is disabled such that the fob is unable to respond to a PEPS request signal transmitted from a vehicle control module. The fob receiver may comprise an LF receiver or an RF transceiver. Where the fob further comprises at least one user operable switch, the method may further comprising enabling a normal operating mode in response to actuation of the at least one switch such that the receiver is enabled and the fob is able to respond to a PEPS request signal transmitted from a vehicle control module.

Where the fob further comprises a transponder configured for battery-less operation, the method may further comprise enabling a normal operating mode in response to a low frequency signal received by the transponder such that the receiver is enabled and the fob is able to respond to a PEPS request signal transmitted from a vehicle control module. Where the fob further comprises a port in communication with the controller and configured to receive a wired connection, the method may further comprise enabling a normal operating mode in response to a wake-up signal received by the controller via the wired connection such that the receiver enabled and the fob is able to respond to a PEPS request signal transmitted from a vehicle control module.

As is readily apparent from the foregoing, embodiments of a fob and a method for operating a fob for a passive entry-passive start (PEPS) system for a vehicle have been described. Such embodiments of a fob and a method for operating such a fob are able to extend the shelf-life of a fob battery. The embodiments described include a portable, remote control device, such as a fob, having a normal operating mode and a low current consumption mode, and comprising a battery, an LF receiver or RF transceiver, and a controller.

The controller may be configured to place the fob in the low current consumption mode wherein an LF receiver or RF transceiver is disabled and wherein the fob is unable to respond to PEPS requests from a vehicle control module. The controller may also be configured to enable a normal operating mode wherein the LF receiver or RF transceiver is enabled and the fob is able to respond to a PEPS request signal from the vehicle control module. The fob may include user operable switches, an LF transceiver and/or a port configured for a wired connection to the controller. The controller may enable a normal operating mode in response to user actuation of a fob switch, in response to an LF command received by the LF transponder operating in a battery-less operating mode, or in response to a signal received over a wired connection. In such a battery-less transponder operating mode, the field of an LF signal from an LF antenna associated with the vehicle control module may provide power for operating the fob and an LF command sent from the vehicle control module may be used to awaken the fob controller and restore the fob to the normal operating mode in which the fob LF receiver or RF transceiver is turned on for responding to PEPS requests from the vehicle control module.

While various embodiments of a fob and a method for operating a fob for a passive entry-passive start (PEPS) system for a vehicle have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A remote function fob for a passive entry-passive start (PEPS) system for a vehicle, the fob comprising:
a battery;
a low frequency (LF) receiver; and
a controller configured to enable a low current consumption mode wherein the LF receiver is disabled such that the fob is unable to respond to a PEPS request signal transmitted from a vehicle control module.

2. The remote function fob of claim 1 further comprising at least one user operable switch, wherein the controller is further configured to enable a normal operating mode in response to actuation of the at least one switch such that the LF receiver is enabled and the fob is able to respond to a PEPS request signal transmitted from a vehicle control module.

3. The remote function fob of claim 1 further comprising a transponder adapted for battery-less operation, wherein the controller is further configured to enable a normal operating mode in response to an LF signal received by the transponder such that the LF receiver is enabled and the fob is able to respond to a PEPS request signal transmitted from a vehicle control module.

4. The remote function fob of claim 1 further comprising a radio frequency (RF) transmitter, wherein the RF transmitter is disabled in the low current consumption mode.

5. The remote function fob of claim 1 wherein the low current consumption mode comprises a storage mode wherein a shelf-life of the battery is extended.

6. The remote function fob of claim 1 wherein the controller enables the low current consumption mode in response to receipt of a command signal.

7. The remote function fob of claim 1 further comprising a plurality of LF antennas for use with the LF receiver and the transponder, each of the plurality of LF antennas having a different orientation to improve reception of an LF signal.

8. A remote function fob for a passive entry-passive start (PEPS) system for a vehicle, the fob comprising:
a battery;
a radio frequency (RF) transceiver; and
a controller configured to enable a low current consumption mode wherein the RF transceiver is disabled such that the fob is unable to respond to a PEPS request signal transmitted from a vehicle control module.

9. The remote function fob of claim 8 further comprising at least one user operable switch, wherein the controller is further configured to enable a normal operating mode in response to actuation of the at least one switch such that the RF transceiver is enabled and the fob is able to respond to a PEPS request signal transmitted from a vehicle control module.

10. The remote function fob of claim 8 further comprising a transponder configured for battery-less operation, wherein the controller is further configured to enable a normal operating mode in response to a low frequency signal received by the transponder such that the RF transceiver is enabled and the fob is able to respond to a PEPS request signal transmitted from a vehicle control module.

11. The remote function fob of claim 8 further comprising a port in communication with the controller and configured to receive a wired connection, wherein the controller is further configured to enable a normal operating mode in response to a wake-up signal received via the wired connection such that the RF transceiver is enabled and the fob is able to respond to a PEPS request signal transmitted from a vehicle control module.

12. The remote function fob of claim 8 wherein the low current consumption mode comprises a storage mode wherein a shelf-life of the battery is extended.

13. The remote function fob of claim 8 wherein the controller enables the low current consumption mode in response to receipt of a command signal.

14. The remote function fob of claim 8 further comprising at least one component selected from the group comprising a light emitting diode, a piezoelectric sound generator, and a vibration generating motor, and wherein the low current consumption mode includes disabling the at least one component.

15. A method for operating a remote function fob for a passive entry-passive start (PEPS) system for a vehicle, the fob comprising a battery, a receiver, and a controller for controlling operation of the fob, the method comprising:
enabling a low current consumption mode wherein the receiver is disabled such that the fob is unable to respond to a PEPS request signal transmitted from a vehicle control module.

16. The method of claim 15 wherein the fob further comprises at least one user operable switch, the method further comprising enabling a normal operating mode in response to actuation of the at least one switch such that the receiver is enabled and the fob is able to respond to a PEPS request signal transmitted from a vehicle control module.

17. The method of claim 15 wherein the fob further comprises a transponder configured for battery-less operation, the method further comprising enabling a normal operating mode in response to a low frequency signal received by the transponder such that the receiver is enabled and the fob is able to respond to a PEPS request signal transmitted from a vehicle control module.

18. The method of claim 15 wherein the fob further comprises a port in communication with the controller and configured to receive a wired connection, the method further comprising enabling a normal operating mode in response to a wake-up signal received by the controller via the wired connection such that the receiver enabled and the fob is able to respond to a PEPS request signal transmitted from a vehicle control module.

19. The method of claim 15 wherein the receiver comprises a low frequency (LF) receiver.

20. The method of claim 15 wherein the receiver comprises a radio frequency (RF) transceiver.
